(19) United States
(12) Patent Application Publication
(10) Pub. No.: US 2002/0144416 A1
(43) Pub. Date: Oct. 10, 2002

(54) Target object for automated measuring instruments

(75) Inventor: Helmut Ghesla, Hard (AT)

Correspondence Address: FOLEY AND LARDNER, SUITE 500, 3000 K STREET NW, WASHINGTON, DC, 20007, US

(73) Assignee: Leica Geosystems AG

(21) Appl. No.: 10/103,131

(22) Filed: Mar. 22, 2002

(30) Foreign Application Priority Data
Mar. 23, 2001 (CH) 2001 0540/01

(51) Int. Cl. G01C 15/02

(52) U.S. Cl. 33/293

(57) ABSTRACT

In a target object (100) according to the invention, eight triple prisms (1, 2, 5, 6) are arranged in the form of two pyramids which are oriented with their base surfaces to one another. The triple prisms (1, 2, 5, 6) are aligned in such a way that, in the position of use, on the one hand optical beams from a predetermined range of vertical directions (v) above or below a horizontal plane (h), in any desired azimuthal alignment (a) of the target object (100) are continuously triple-reflected with high intensity and, on the other hand, abrupt, interfering reflections are as far as possible avoided. This is effected by alignment, according to the invention, of the reflective surfaces of the eight triple prisms (1, 2, 5, 6) of the target object parallel or perpendiucular to the horizontal plane (h). Consequently, the interfering reflections can be minimized in the relevant directional operating range of the target objects.

The invention relates to a target object for optoelectronically carrying out automatic target trackings, target acquisitions and/or distance measurements from a predetermined range of vertical directions above or below a predetermined horizontal plane in any desired azimuthal alignment according to the precharacterizing clause of claim 1.

In geodetic surveying, in construction surveying and in industrial measurement technology, sought coordinates for points to be surveyed are often determined indirectly via target objects. The target objects assume predetermined positions relative to the points to be measured. By means of measuring instruments, the positions of the target objects relative to the positions of the measuring instruments are then measured. In addition to the azimuthal or the vertical direction value relative to the target object, the distance value between the target object and the measuring instrument can additionally be determined optoelectronically by said measuring instrument by means of retroreflecting target objects. Consequently, the position determination can be carried out in a simple manner in practice by means of retroreflecting target objects. As a rule, retroreflecting target objects have triple prisms, reflective foils or spherical reflectors.

In industrial surveying, chromium-plate steel spheres are frequently used as spherical reflectors. Since they can be sighted from any desired vertical direction and independently of their azimuthal alignment and always give a circular contour having an unambiguous centre, they are ideal target objects for pure direction determinations. Since that part of optical beams retroflected by a spherical surface is relatively small and moreover decreases as the fourth power of the distance between the measuring instrument and the spherical reflector, spherical reflectors are suitable only for optoelectronic distance measurements of a few meters.

In construction and geodetic surveying, in general retroreflecting reflective foils or triple prisms are therefore used. Their substantially higher degrees of retroreflection permit distance measurements over hundreds or thousands of meters. In contrast to the spherical reflectors, however, they retroreflect optical beams only in a limited vertical direction range within a limited azimuthal alignment range of the triple prisms or of the reflective foils. Typically, optical beams in ranges of 90° are retroreflected horizontally and vertically with high intensity. Triple prisms or reflective foils should therefore be roughly aligned with the respective measuring instruments before distance measurements can be performed by means of them.

U.S. Pat. No. 5,301,435 discloses an all-round reflector which retroreflects optical beams with high intensity independently of its azimuthal alignment. The all-round reflector has six triple prisms, each having a circular pupil surface for optical beams which are regularly distributed over a cylindrical surface. In each case, three triple prisms are spatially separated, offset 120° relative to one another, each arranged in a plane. The two planes are in turn rotated through 60° relative to one another and arranged one on top of the other. Since each prism by itself covers a retroreflecting direction range, this all-round reflector is suitable for distance measurements from a predetermined range of vertical directions in any desired azimuthal alignment. The individual centres of gravity of the reflection ranges of the triple prisms spatially separated from one another are likewise distributed over a cylindrical surface, separately from one another. Measuring instruments comprising optoelectronic distance measuring means or automatic target acquisition means, however, assign different positions to such an all-round reflector, depending on its azimuthal alignment. The coordinates of these positions may differ by several centimeters. Such all-round reflectors can therefore reasonably be used as target objects for surveys with reduced accuracy requirements only above a certain minimum distance of about 1000 m.

EP 0 846 278 B1 discloses an all-round reflector comprising special triple prisms which have triangular pupil surfaces for optical beams. As a result of this special shape, the pupil surfaces of the triple prisms are adjacent to one another if the triple prisms are joined together directly with their reflective surfaces. The distance between the centres of gravity of the respective reflection ranges of the triple prisms can thus be minimized. The six triple prisms are combined in the form of a regular octahedron. In the position of use, two lateral surfaces of this octahedron are aligned horizontally. Apart from these two lateral surfaces, each other lateral surface is formed by the pupil surface of one of the six triple prisms. The disadvantages of the all-round reflector disclosed in U.S. Pat. No. 5,301,435 can be reduced by this arrangement of the triple prisms to such an extent that distance measurements in the close-up range up to a few meters are also possible. In the case of surveying applications which meet average, geodetic accuracy requirements, such all-round reflectors described in EP 0 846 278 B1 have also often proved useful as target objects for measuring instruments having automatic target acquisition. Above a certain minimum distance of about 50 m, such all-round reflectors can also be used as target objects for measuring instruments having automatic target tracking. Below this distance, however, interfering reflections which can confuse the automatic target tracking and cause it to cease functioning occur abruptly depending on the azimuthal alignment of the all-round reflector described in EP 0 846 278 B1. This problem occurs in particular in the case of all-round reflectors which are mounted on plumbing rods and held by persons. During transport of the all-round reflector between the individual measuring points, changes in its azimuthal alignment inevitably occur. Small changes in the azimuthal alignment are also possible during manual alignment and positioning of the plumbing rod. The interfering reflections of the all-round reflector which may thus be caused can not only impair the accuracy of the measurements but also confuse the automatic target tracking in the determination of the expected trajectory of the all-round reflector. This can lead to a displacement of the acquisition range of the measuring instrument away from the all-round reflector. A further acquisition of the all-round reflector by the measuring instrument is then required.

It is therefore the object of the invention to eliminate the deficiencies of the prior art. In addition, it is also intended to propose target objects for automatically target tracking, automatically target acquiring and/or distance measuring instruments which retroreflect beams substantially continuously and in a stabilized manner in space from a predetermined range of vertical directions above or below a predetermined horizontal plane, also in the case of changing azimuthal alignment—a precondition for rugged, automatic target tracking—or permit, by means of such a target object, surveys with accuracies of a few millimeters independently of its azimuthal alignment.

This object is achieved by a target object in which the features of the independent Patent Claims are realized.

Advantageous or alternative embodiments of the invention are mentioned in the dependent Patent Claims.

When triple prisms are mentioned in association with the invention, they are to be understood in the widest sense as meaning differently formed bodies of transparent materials for the retroreflection of optical beams, which have a flat pupil surface of in principle any desired form, for example trapezoidal, triangular or hexagonal, for entry or exit of the beams into or out of the body and three flat reflection surfaces oriented in each case at right angles to one another with triple reflection of said beams.

In contrast to the use of six triple prisms in a conventional all-round reflector, which are arranged, for example, in the form of an octahedron lying on a lateral surface, in the target object according to the invention eight triple prisms are arranged in the form of two pyramids which are oriented with their base surfaces facing one another. In principle, pyramids can be freely rotated relative to one another. The triple prisms are aligned in a target object according to the invention in such a way that optical beams emitted in the position of use from a predetermined range of vertical directions above or below a horizontal plane, in any desired azimuthal alignment of the target object, are triple-reflected with high intensity on the one hand and, on the other hand, abrupt interfering reflections are as far as possible avoided. This occurs by alignment of the reflective surfaces of the eight triple prisms of the target object according to the invention parallel or perpendicular to the horizontal plane. The interfering reflections occurring in addition to the solely desired triple reflections are caused in particular by double reflections and to a small extent by 7-fold reflections by the triple prisms. As a result of the alignment according to the invention, the interfering reflections occur in particular in the vertical directions outside the predetermined range of vertical directions, below or above the horizontal plane. Consequently, the interfering reflections can be minimized in a relevant working direction range of the target objects.

As a result of this alignment of the triple prisms of a target object, the rays of a beam lobe of a measuring instrument from the predetermined range of vertical directions are reflected not only, as in the case of a conventional all-round reflector, by one, two or three triple prisms but by two or four triple prisms. In addition to levelling, this also increases the level of the intensity curve of the reflected beams via the azimuthal alignment of the target object. The former, together with the compact and cohesive form of the total reflection range of a target object according to the invention, increases the suitability as a target object for automatic target trackings, compared with a conventional all-round reflector. The latter increases the range of use of these target objects.

When measuring instruments having automatic target acquisition are referred to in association with the invention, this is to be understood as meaning measuring instruments which emit a lobe of optical beams to stationary retroreflectors and determine the direction of the common centre of gravity of the reflection ranges of the retroreflectors with the aid of an extensive sensor in the form of, for example, a CCD array.

When measuring instruments having automatic target tracking are referred to in association with the invention, this is to be understood as meaning measuring instruments by means of which automatic target acquisitions to moving retroreflectors are carried out continuously. Owing to the respective measured positions of the common centre of gravity of the reflection ranges of the retroreflector, the beam lobe is continuously aligned in each case with the next expected position of the moving retroreflector.

An advantageous further development of the invention is the arrangement of eight triple prisms in the form of an octahedron standing vertically on a vertex in the position of use. Here, the individual reflection ranges of the triple prisms are present in pairs vertically one on top of the other with in each case a reflection range below and above the horizontal plane. Consequently, the changes in the vertical coordinates of the position of the centre of gravity of the reflection areas can be minimized independently of the azimuthal alignment of the target object. This also gives a relationship between the vertical direction in which the target object is measured and the deviation of the measured horizontal coordinate value. This relationship could, if required, be used for corrections of the measured values.

As a result of the arrangement and alignment, according to the invention, of the triple prisms, interfering reflections and hence associated, abrupt changes in the position of the common centre of gravity of the reflection ranges of the triple prisms can be minimized. During target tracking, these abrupt changes simulate apparent movements of the target object, which in turn can result in the beam lobe being displaced away from the target object. Minimization of the interfering reflections of the target object results in a decisive increase in the ruggedness of automatic target trackings and possibly in an improvement in the accuracy and reliability of the measured values.

The arrangement and alignment, according to the invention, of the triple prisms also results in a compact common reflection range of the target object. On the one hand, substantial interfering reflections occur only together with desired triple reflections in the case of triple prisms arranged and aligned according to the invention. This leads in general to a continuous reflection range. On the other hand, the reflection ranges of adjacent triple prisms are adjacent to one another. Consequently, the entire target object also has a continuous, compact, common reflection range. Thus, interfering reflections do not occur abruptly.

For conveniently handling and simply storing and for transporting the target object, as well as for any desired horizontally aligned arrangement of the target object, for example on wall surfaces, a receiving part is arranged on the target object, in particular on the pyramid vertex. A counter-piece which is provided, for example, on one end of the plumbing rod can be pushed onto, snapped into or screwed into this receiving part. If the target object is to be used, for example, in regions fairly close to the ground, it is advantageous to provide two receiving parts opposite one another, it being possible to provide one for receiving a plumbing rod and the other for receiving a holding part.

To protect the triple prisms from damage, protective devices which—similarly to the holders disclosed in DE-A1-195 30 809—are in the form of pyramidal caps or caps in the form of a truncated pyramid can be mounted at least on one side.

The invention is illustrated in more detail below, purely by way of example, with reference to the Figures shown in the drawing.

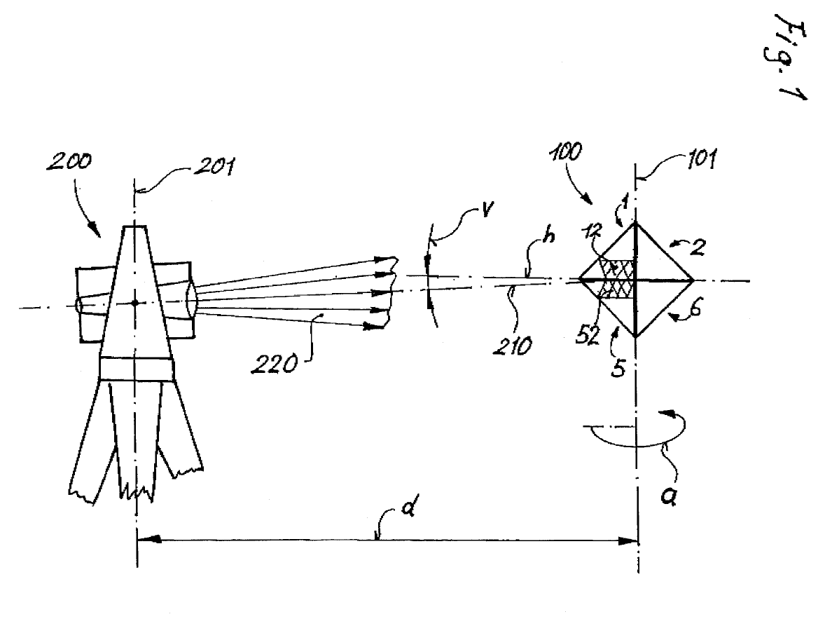

FIG. 1 shows a side view of a measuring arrangement comprising a target object according to the invention and a measuring instrument;

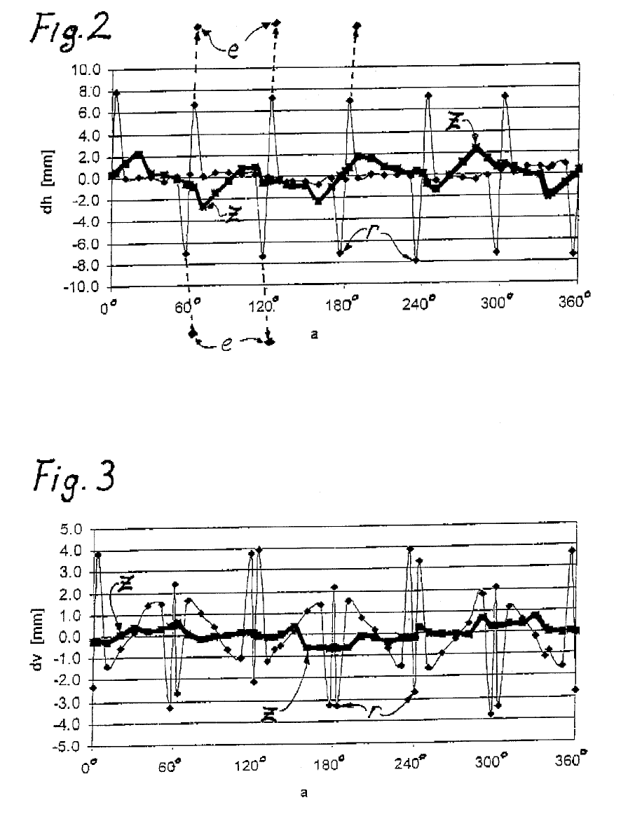

FIG. 2 shows a diagrammatic comparison of measured, horizontal coordinate values of a target object according to the invention and of an all-round reflector corresponding to the prior art, as a function of their azimuthal alignment;

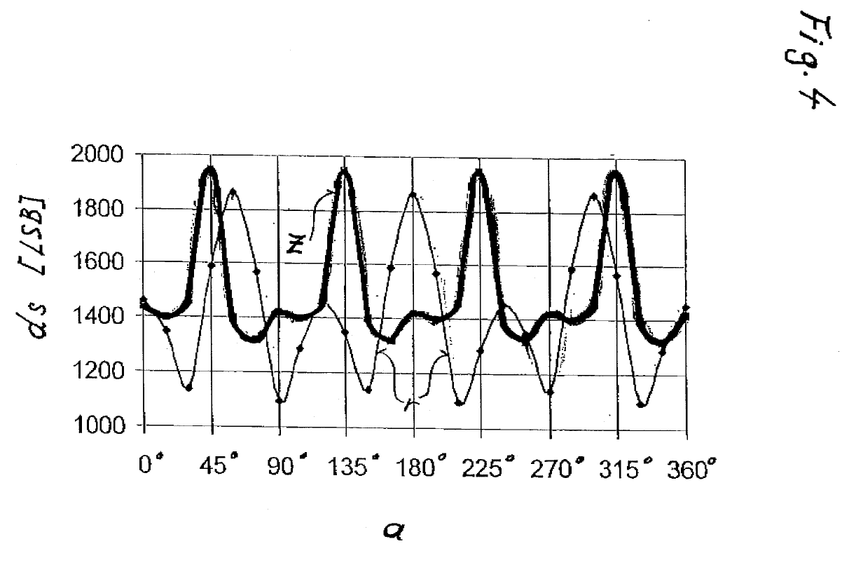

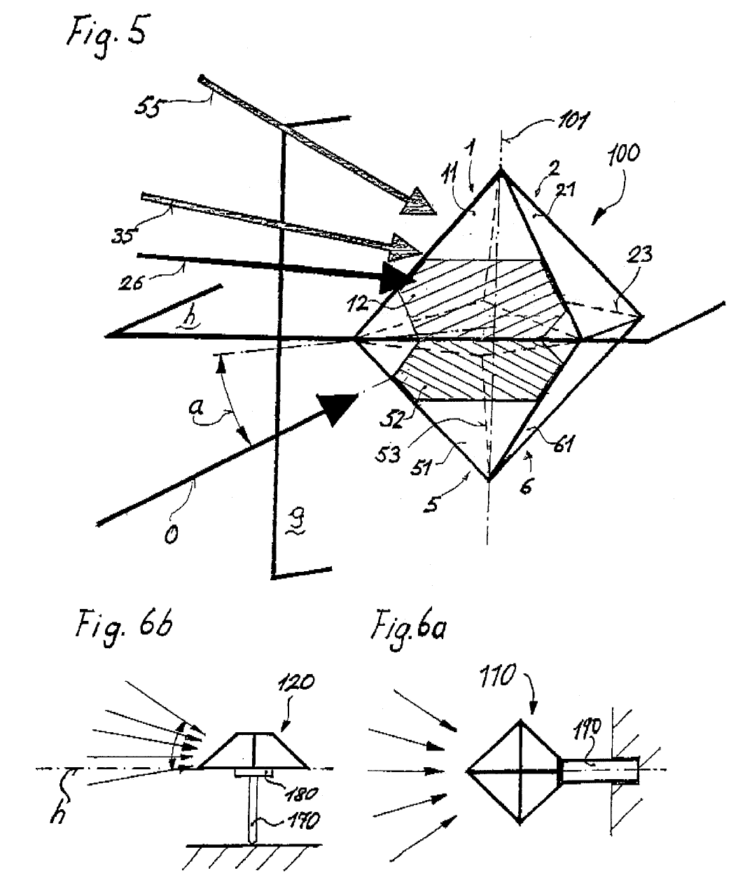

FIG. 3 shows a diagrammatic comparison of measured, vertical coordinate values of a target object and of an all-round reflector corresponding to the prior art, as a function of their azimuthal alignment;

FIG. 4 shows a diagrammatic comparison of measured intensity values of the reflected beams of a target object according to the invention and of an all-round reflector corresponding to the prior art, as a function of their azimuthal alignment;

FIG. 5 shows an oblique view of a target object according to the invention, with directional arrows indicating incident beams;

FIG. 6a shows a side view of a target object according to the invention, mounted on a wall and with directional arrows indicating incident beams;

FIG. 6b shows a side view of a target object with directional arrows from a reduced vertical direction range of incident beams;

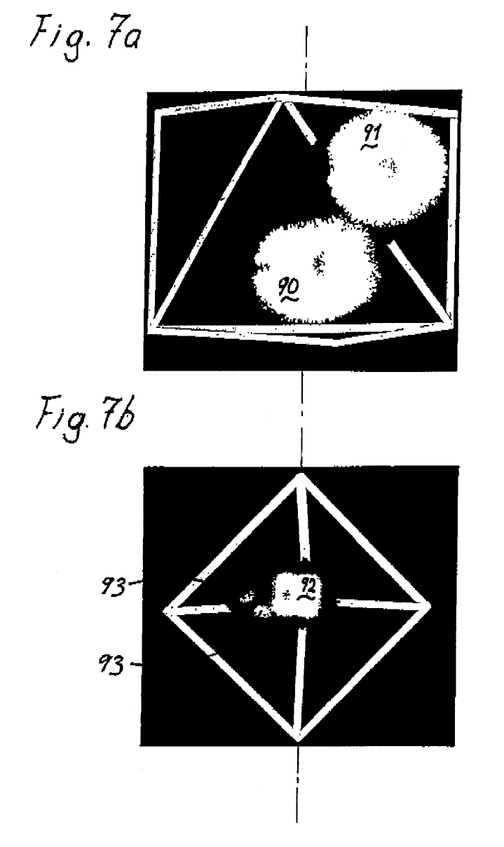

FIG. 7a shows an illustration of the distribution of beams retroreflected by an all-round reflector corresponding to the prior art and

FIG. 7b shows an illustration of the distribution of beams retroreflected by a target object according to the invention.

FIG. 1 shows a measuring arrangement for determining the three-dimensional position of an octahedral target object 100 according to the invention by a measuring instrument, for example a tacheometer 200 with automatic target acquisition and target tracking. The tacheometer 200 is mounted in a stationary manner on a tripod. It has a vertical axis 201 and a target axis 210 pivotable about a vertical axis. The tacheometer 200 emits a beam lobe 220 which approximately determines the cross-section of the acquisition space of the automatic target acquisition or target tracking.

The target axis 210 substantially forms the centre of the beam lobe 220. During each position determination, the target acquisition determines the common centre of gravity of reflection ranges 12, 52, 42, 82 (42 and 82 not visible in FIG. 1) of the target object 100, in which the beams of the beam lobe 220 are reflected back to the tacheometer 200. The target axis 210 is aligned with the common centre of gravity and its three coordinates in space are determined by the tacheometer 200.

In the present embodiment, the octahedral target object 100 has eight rotationally symmetrical, tetrahedral triple prisms 1, 2, 5 and 6 of identical design (3, 4, 7 and 8 are not visible in FIG. 1). Each of the triple prisms 1 to 8 has three flat reflective surfaces aligned perpendicularly to one another, for a triple reflection of optical beams, and a pupil surface tilted relative to said reflective surfaces, for passage of optical beams. The eight triple prisms 1 to 8 are combined in such a way that all reflective surfaces lie substantially in three common planes. A horizontal plane h, which is intersected by the target axis 210 at a vertical sighting angle v, passes through the point of intersection of these three planes. An alignment axis 101 of the target object 100 passes through the point of intersection of the three planes and parallel or perpendicular to the respective reflective surfaces. The target object 100 is mounted in a stationary manner so as to be rotatable about the alignment axis 101. The alignment axis 101 is a distance d away from the vertical axis 201. An azimuthal alignment of the target object 100, for example relative to the direction of the connecting line between the vertical axis 201 and the alignment axis 101, defines an azimuthal alignment angle a.

FIG. 2 shows a diagrammatic comparison of the changes in the horizontal coordinate value of the measured position of an all-round reflector corresponding to the prior art, on the one hand, and of the target object 100 according to the invention from FIG. 1, on the other hand, as a function of their azimuthal alignment. An all-round reflector corresponding to the prior art is disclosed in EP 0 846 278 B1 and is described above. The measured values for the comparisons of FIG. 2, FIG. 3 and FIG. 4 were each determined using measuring arrangements which correspond to the measuring arrangement from FIG. 1 and have the following common features. The tacheometer 200 is an instrument of the TCA 1102 series from Leica Geosystems AG. The distance d has a value of 3 m and the vertical sighting angle v has a value of −3°.

The target object 100 shown in the measuring arrangement from FIG. 1 has, for example, an azimuthal alignment angle a with a value of 0°. Such comparisons in distances d of 1.5 m to about 50 m with sighting angles v between −10° and +10° have substantially comparable variations of the measured values.

The respective azimuthal alignment angle of the all-round reflector and of the target object 100 are plotted along the abscissa of the diagrammatic comparison. In each case the measured deviations of the horizontal coordinate values from their mean values are plotted along the ordinate.

The deviations of the horizontal coordinate values ah of the measured, common centre of gravity of the reflection ranges of the all-round reflector are represented by small rhombuses which are connected by lines r. Periodically every 60° of azimuthal alignments, the measured centre of gravity has relatively large and abrupt changes within a relatively small range of azimuthal alignments. Small changes in the azimuthal alignment occur regularly when all-round reflectors mounted on plumbing rods are moved by persons. These abrupt changes are caused in particular by double reflections. These occur at those reflective surfaces of the triple prisms adjacent to the respective, frontally illuminated triple prisms which are flush at the rear. The reflection ranges of the double reflections are a distance away from the reflection range of the triple reflection of the frontally illuminated triple prism. This leads to abrupt changes in the measured position, which simulates an apparent movement during the automatic target tracking of the tacheometer 200 from FIG. 1. Based on the last change of the measured positions, the target tracking now calculates a next expected position e and aligns the beam lobe 220 from FIG. 1 of the tacheometer 200 therewith. In the close-up range, below about 50 m, relatively large, abrupt changes in the positions can therefore lead to an unintentional displacement of the beam lobe 220 away from the all-round reflector. The automatic target tracking has lost the all-round reflector and measurement is interrupted. The all-round reflector must now be searched for again and acquired by the tacheometer 200, and the target tracking can then be resumed.

The deviations of the horizontal coordinate values ah of the measured, common centre of gravity of the reflection ranges of the target object 100 according to the invention are on the other hand represented by small squares, which in turn are connected to one another by lines z. In contrast to the all-round reflector, in the case of the target object 100 the curve of the horizontal coordinates has substantially constant, moderate positive or negative slopes without jumps between the individual measured values. Furthermore, the number of local extremes is reduced from twelve to eight and their magnitudes are reduced several times. Because the coordinate variation z substantially represents a harmonic oscillation with a relatively small amplitude, target loss by the automatic target tracking due to interfering reflections is no longer very probable.

FIG. 3 shows a comparison of the deviations of the vertical coordinate values av of the measured positions of the all-round reflector corresponding to the prior art and of the target object 100 as a function of their azimuthal alignment, which comparison corresponds to the diagrammatic comparison from FIG. 2.

The deviations from the mean value of the vertical coordinates av of the all-round reflector (represented by rhombuses and connected by lines r) once again show abrupt deflections with the same azimuthal alignment. Although these do not even have half the magnitudes of the horizontal deflections, as many as four abrupt changes between four local extreme values occur within a relatively small range of azimuthal alignments. The phase coincidence of the abrupt changes of the horizontal and vertical coordinate values of the all-round reflector increase the probability of a displacement of the beam lobe 220 away from the all-round reflector.

The deviations of the vertical coordinates av of the target object 100 (represented by squares and connected by lines z) still have a magnitude of substantially less than one millimeter. Consequently, a target object according to the invention is suitable in particular for automated measuring applications with high accuracy requirements in the vertical direction, such as, for example, for machine controls of asphaltspreading machines, road graders, bulldozers, etc.

FIG. 4 shows a comparison of the measured intensity of the beams which are reflected back to the tacheometer 200 from FIG. 1 by the all-round reflector corresponding to the prior art and by the target object 100 according to the invention, as a function of their azimuthal alignment, which comparison corresponds to the diagrammatic comparison from FIG. 2. The azimuthal alignment is represented in each case by the value of the alignment angle a and the intensity by the respective value of the extensive sensor signal ds digitized in least significant bits [lsb].

The measured values of the target object 200 according to the invention from FIG. 1 (in FIG. 4, represented by small squares and connected by lines z) exhibit a smoother curve and on average between 10 and 20% higher intensity values.

FIG. 5 shows the target object 100 according to the invention from FIG. 1 in an oblique view. Of the eight triple prisms 1 to 8, only the four triple prisms 1, 2, 5, 6 are visible. In this embodiment, the triple prisms 1 to 8 are made of glass. The horizontal plane h from FIG. 1 and a reflection surface plane g oriented at right angles to said horizontal plane are also shown. One reflective surface each of the triple prisms 1 to 8 lies both in the horizontal plane h and in the reflection surface plane g.

The four arrows 0, 26, 35, 55 represent four different vertical directions from which the target object 100 can in each case be illuminated, for example by means of the beam lobe 220 of the tacheometer 200 from FIG. 1. The azimuthal alignment angle a, a measure of the azimuthal alignment of the target object 100, can be defined, for example, by the angle between the reflection surface plane g and the vertical plane which is bounded by the four incident arrows.

If the target object 100 is frontally illuminated by means of the beam lobe 220 in the direction of the arrow 0 with a vertical alignment angle v (cf. FIG. 1) of 0°, the optical beams of the beam lobe 220 pass through the pupil surfaces 11, 51 of the triple prisms 1, 5. The beams which pass through the reflection regions 12, 52 also leave the prism again through these. According to the invention, in the horizontal sighting direction, the common centre of gravity of the reflection regions 12, 52 lies in the horizontal plane h.

If the azimuthal alignment of the target object 100 is changed by a counterclockwise rotation about the alignment axis 101, the pupil surfaces 21, 61 of the adjacent triple prisms 2, 6 are also illuminated by the beam lobe 220. However, relevant interfering reflections do not occur since firstly a large part of the beams are reflected through the large angle between the surface normals of the pupil surfaces 21, 26 and of the beam lobe 220 by Freznel reflections at the pupil surfaces 21, 61. Secondly, the pupil surfaces 21, 61 have only small reflection regions since reflection surface edges 23, 63 (only the virtual image of the reflection surface edge 23 is visible in FIG. 5) which are formed by those reflective surfaces of the triple prisms 2, 6 which are responsible for the interfering double reflections are aligned in a relatively acute angle to the incident beams. Thirdly, the interfering double reflections occur together with the desired triple reflections at the respective two triple prisms 2, 6, with the result that the double reflections are relativized and stabilized.

If, on the other hands the target object 100 is frontally illuminated in the direction of the arrow 26 with a specific, vertical sighting angle, an interfering reflection occurs at the triple prism 5. If the glass of the triple prisms 1 to 8 has a refractive index of 1.52, the calculated value for the specific, vertical sighting angle is 26.08°. This interfering reflection is caused by a double reflection of the beams at the two reflective surfaces which form the reflection surface edge 53 (only its virtual image is visible in FIG. 5). However, since this interfering reflection occurs together with a desired triple reflection at the triple prism 5 and an even stronger, desired triple reflection at the triple prism 1, the interfering reflection is highly relativized and stabilized. Moreover, this interfering reflection is present in a vertical plane with the two triple reflections so that the measured, horizontal coordinates are not influenced at all by this interfering reflection. In practice, however, sighting angles occur very rarely in the immediate vicinity of the specific, vertical sighting angle in automatically target-tracking surveys and they are therefore no longer envisaged in the working area of target objects. In the case of changes to the azimuthal alignment of the target object, the specific, vertical sighting angle triggering this interfering reflection decreases only slightly.

If the target object 100 rotated counterclockwise is illuminated from a directional region between the two arrows 35, 55 with vertical sighting angles v between 35° and 55°, strong and unstable interfering reflections occur at the triple prism 2. However, when automatically target-tracking measuring instruments are used for measurement in the field, such steep sighting angles v do not as a rule occur. These interfering reflections are comparable with interfering reflections which can occur in the case of the conventional all-round reflectors in the position of use in the working range at sighting angles between +10° and −10° about the horizontal plane.

FIG. 6a shows a further embodiment of a stationary target object 110 according to the invention, for example a stationary fastening to walls for fixing a reference system. In addition to the eight octahedrally arranged triple prisms, such a stationary target object 110 has, at one vertex, a bolt 190 which has an operative mechanical connection to the wall. If beams which intersects the axis of the bolt 190 at an angle of less than about 35° are directed at the stationary target object, said beams are retroreflected without relevant interfering reflections.

FIG. 6b shows a further embodiment of a target object 120 which is in the form of a truncated pyramid and is suitable for applications having a reduced vertical range of vertical sighting angles below the horizontal plane h. The target object 120 has only four triple prisms which are mounted here on a plumbing rod 170 by means of a receiving part 180. The target object 120 has no pyramid vertex since this does not significantly contribute to the triple reflections in the range of vertical directions which is indicated by the arrows. Such a target object 120 retroreflects a correspondingly smaller proportion of the optical beams of the beam lobe. Owing to the refractive effect of the transparent material of the triple prisms for optical beams, optical beams which are incident on such a target object 120 from directions below the horizontal plane h are also retroreflected.

FIGS. 7a and 7b illustrate the distribution of the optical beams of the beam lobe of the above-mentioned tacheometer TCA1102 which are retroreflected by the all-round reflector according to the prior art or by the target object according to the invention. The figures are based on measuring setups which, with the exception of the distance d (cf. FIG. 1), are identical to the measuring setup of FIG. 2, 3 and 4. The measuring setup of FIG. 7a has a distance d of 3.5 m and that of FIG. 7b has one of 5 m. The beam lobe emitted by the tacheometer is partly retroreflected by the retroreflector or by the target object and is focused by the tacheometer onto its extensive sensor in the form of a CCD array.

FIG. 7a shows a distribution of the beams retroreflected by the all-round reflector, where, owing to the azimuthal alignment of the all-round reflector, the influence of the interfering double reflection is particularly great. Three triple prisms whose edges—for better assignability—have been partly introduced into the figure are illuminated by the beam lobe. The figure shows two dominant reflection regions 90, 91. The first, dominant reflection region 90 coordinated with the middle triple prism is determined substantially by the desired triple reflection stabilized in two directions in space by means of the three reflection surface edges. On the other hand, the second, likewise dominant reflection region 91 coordinated with the right triple prism is determined substantially by an interfering double reflection stabilized in only one direction in space by means of only one reflection surface edge. This double reflection occurs completely abruptly according to the azimuthal alignment of the all-round reflector. The two dominant reflection regions 90, 91 occur a distance apart in the peripheral region of the all-round reflector and do not form a common reflection region. A relatively small change in the azimuthal alignment of the all-round reflector results in a major change in the ratio of the magnitudes of the two dominant reflection regions 90, 91. Since the two dominant reflection regions 90, 91 in FIG. 7a are a relatively large distance apart, correspondingly large changes in the coordinates of the centre of gravity of the common reflection region of the all-round reflector result. In the case of a further change in the azimuthal alignment, the double reflection at the right triple prism may disappear abruptly. Now, the solely desired triple reflections substantially determine the common reflection regions of the triple prisms of the all-round reflector. In the case of further changes in the azimuthal alignment, another dominant double reflection can occur abruptly, this time at the left triple prism, and can disappear again. Such effects are responsible for the periodically occurring, abrupt outliers of the coordinate curves r from FIGS. 2 and 3 and for the errors in instruments with automatic target tracking which result therefrom.

In FIG. 7b, on the other hand, the illustration of the distribution of the beams retroreflected by a target object according to the invention has only one dominant, compact reflection region 92 lying in the central region of the target object and two smaller reflection regions 93. Four triple prisms whose edges once again have been partly introduced into the figure are illuminated by the beam lobe. The compact reflection region 92 is composed of four directly adjacent reflection regions of one triple prism each. Each of the four reflection regions is substantially determined by a triple reflection stabilized in two directions in space. In comparison with the compact reflection region 92, the two smaller reflection regions 93 which are substantially determined by double reflections stabilized only in one direction in space retroreflect only a fraction of the retroreflected beams. One of the smaller reflection regions 93 is moreover present directly adjacent to the compact reflection region 92. The other is slightly further away therefrom. Owing to their small proportion of the retroreflection and their relative proximity to the compact reflection region 92, these smaller reflection regions 93 are of correspondingly little importance for the centre of gravity of the common reflection region of the target object according to the invention.

The coordinate curve z of the centre of gravity of the common reflection region in FIGS. 2 and 3 therefore has negligible regularities compared with the prior art. Rugged, automatic target tracking—free of troublesome interruptions to work through target loss owing to interfering reflections—is thus possible also at distances of less than 50 m—in the extreme case up to 1.5 m—between the target object according to the invention and the tacheometer.

1. Target object (100, 110) for optoelectronically carrying out automatic target trackings, target acquisitions and/or distance measurements from a predetermined range of vertical directions (v) above or below a predetermined horizontal plane (h) in any desired azimuthal alignment (a), in particular for geodetic, construction and industrial surveying, comprising a plurality of bodies (1, 2, 5, 6) of transparent material, which bodies (1, 2, 5, 6) retroreflect optical beams and each have three optionally metallized, flat reflective surfaces, oriented in each case perpendicular to one another, for reflection of the beams (220), and a flat pupil surface (11, 21, 51, 61) tilted relative to each reflective surface, for passage of the beams (220), characterized in that the target object (100, 110) has eight and only eight bodies (1, 2, 5, 6), at least two reflective surfaces of in each case at least four of the eight bodies (1, 2) being arranged in a pyramidal manner adjacent in each case to one of the reflective surfaces of another of the at least four bodies (1, 2) and—in a position of use of the target object (100, 110)—in each case one reflective surface of each of the eight bodies (1, 2, 5, 6) is aligned substantially parallel to the horizontal plane (h).

2. Target object (100, 110) according to claim 1, characterized in that the first four of the eight bodies (1, 2) are produced in each case from materials having the same refractive index and have one reflective surface each lying in a first plane, and that the second four of the eight bodies (5, 6) are produced in each case from materials having the same refractive index and have one reflective surface each lying in a second plane aligned parallel to the first one.

3. Target object (100, 110) according to claim 2, characterized in that the individual reflective surfaces of different bodies (1, 2, 5, 6) touch one another and the bodies (1, 2, 5, 6) are optionally produced from materials having the same refractive index and optionally have substantially the same external dimensions.

4. Target object (100, 110) according to any of the preceding Claims, characterized in that the eight bodies (1, 2, 5, 6) are arranged octahedrally.

5. Target object (100, 110) according to any of the preceding Claims, characterized in that it has at least one receiving part (180) for receiving a counterpiece which is coordinated, with, for example, a plumbing rod (170), with the result that a detachable, optionally lockable connection between target object and counter-piece, oriented perpendicular to the reflective surface, is permitted.

6. Target object according to claim 4, characterized in that it has at least two receiving parts which in each case are coordinated with opposite regions of the target object.

7. Target object according to any of the preceding Claims, characterized in that it has at least one protective device effective for preventing careless handling, optionally in the region of the receiving parts (180), in particular in the form of a collar in the form of a truncated square pyramid.
